(19) United States
(12) Patent Application Publication
(10) Pub. No.: US 2006/0214774 A1
(43) Pub. Date: Sep. 28, 2006

(54) Desktop system for reading wireless tag and method for controlling reading of wireless tag

(75) Inventor: Sadayoshi Mochida, Numazu-shi (JP)

Correspondence Address: PEARNE & GORDON LLP, 1801 EAST 9TH STREET, SUITE 1200, CLEVELAND, OH, 44114-3108, US

(73) Assignee: TOSHIBA TEC KABUSHIKI KAISHA, Tokyo (JP)

(21) Appl. No.: 11/362,886

(22) Filed: Feb. 27, 2006

(30) Foreign Application Priority Data
Mar. 28, 2005 (JP) JP2005-091415

(51) Int. Cl. H04Q 5/22

(52) U.S. Cl. 340/10.2; 340/572.7

(57) ABSTRACT

A system according to an aspect of the invention includes an article-range finder for finding a range in which an article with an RFID tag is placed; a reader having an antenna for communicating with the RFID tag; and a carrier for carrying the antenna of the reader within the range of the article found.

### CROSS-REFERENCE TO RELATED APPLICATION

This application is based upon and claims the benefit of priority from prior Japanese Patent Application No. 2005-91415, filed on Mar. 28, 2005 the entire contents of which are incorporated herein by reference.

### BACKGROUND OF THE INVENTION

1. Field of the Invention

The present invention relates to desktop systems for reading radio-frequency identification (RFID) tags and method for controlling the reading of radio-frequency identification tags.

2. Description of the Related Art

Readers for reading radio-frequency identification tags stuck to articles generally need to have mount areas of the size suitable for the largest articles with the radio-frequency identification tags. The size of the mount areas tends to increase with the diversification of the line of articles. The increase in the mount areas, i.e., signal transmission and reception areas, allows articles with radio-frequency identification tags to be placed in a wide range.

However, readers having a wide transmission and reception area have increased radio-wave emission and have complicated transmission and reception antennas to ensure accurate communication with radio-frequency identification tags, causing bad influences such as radio wave interference to other electronic devices.

### SUMMARY OF THE INVENTION

The invention has been made in consideration of the foregoing problems of the bad influences such as an increase in radio wave emission and complicated transmission and reception antennas for accurate communication with radio-frequency identification tags. Accordingly, an advantage of the invention is to provide a reader for transmission and reception without bad influences of radio wave interference to other electronic devices.

To achieve the above advantage, one aspect of the present invention is to provide a desktop system for reading a radio-frequency-identification (RFID) tag, the system including: an article-range finder for finding a range in which an article with an RFID tag is placed; a reader having an antenna for communicating with the RFID tag; and a carrier for carrying the antenna of the reader within the found range of the article.

Another aspect of the present invention is to provide a reading system capable of transmission and reception without bad influences of radio wave interference to other electronic devices, and a method for controlling the reading.

### BRIEF DESCRIPTION OF THE DRAWINGS

FIG. 1 is a perspective view showing the overall structure of an embodiment of the invention;

FIG. 2 is a diagram for describing the operation of the embodiment of the invention;

FIG. 3 is a diagram showing the electric structure of the embodiment;

FIG. 4A is a perspective view showing the overall structure of another embodiment; and

FIG. 4B is a perspective view for describing the procedure of the embodiment.

### DETAILED DESCRIPTION OF THE INVENTION

Embodiment of the invention will be described hereinbelow with reference to the drawings.

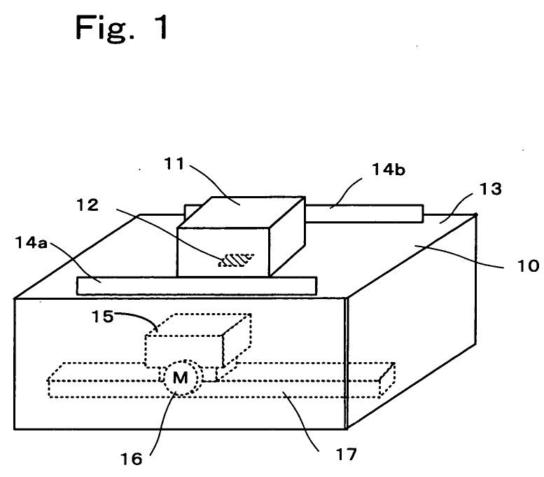

FIG. 1 shows the overall structure of an embodiment of the invention. The system includes: a desktop radio-frequency-identification (RFID)-tag reader 13 for reading information of a radio-frequency identification (RFID) tag 12 stuck to an article 11 placed on a casing 10; a sensor 14 for detecting the position and size of the article 11 placed on the mount surface of the reader 13 using a sensor such as an infrared optical sensor or the like; an antenna 15 built in the RFID-tag reader 13, for transmitting and receiving signals to/from the RFID tag 12; a carrier 16 for carrying the antenna 15 and including, e.g., a drive motor; and a rail 17 that guides and supports the movement of the antenna 15 and the carrier 16.

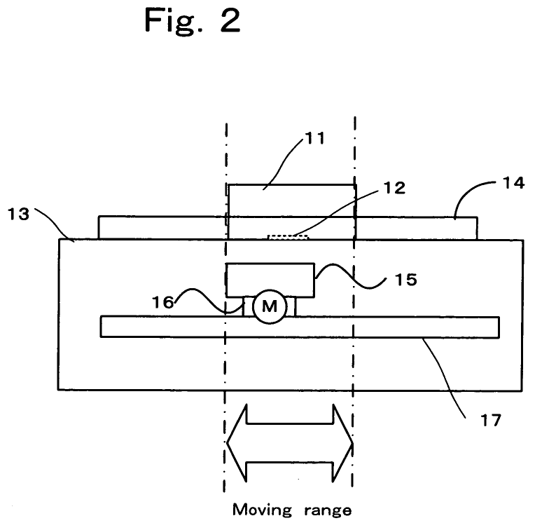

FIG. 2 shows the cross section of the system according to the embodiment of the invention. The alternate long and short dash line in FIG. 2 indicates the moving range of the antenna 15 which is determined in consideration of the position and size of the article 11 with the RFID tag 12 and also a radio-wave range. The antenna 15 moves in the moving range along the rail 17 with the carrier 16. The direction of the movement is determined from the length of the article in one direction.

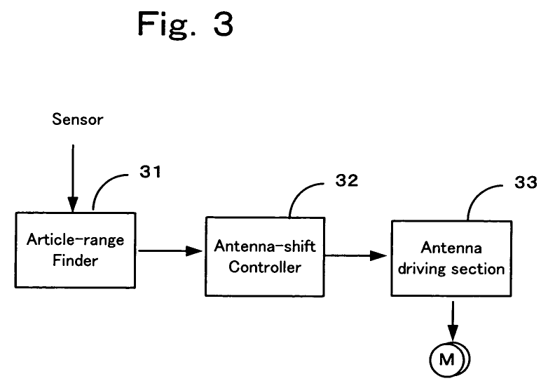

FIG. 3 shows an electric structure of the embodiment. The system includes an article-range finder 31 that senses the range of an article 11 from the position and size of the article 11 using a sensor 14a and a photodetector 14b, an antenna-shift controller 32 that determines the moving range of the antenna 15 from article-range information sensed by the article-range finder 31, and controls the movement of the antenna 15 in the moving range, and an antenna driving section 33 that moves the antenna 15 along the rail 17 using a drive motor M under the control of the antenna-shift controller 32.

The flow of the control of the desktop reader according to the embodiment will be specifically described. The article 11 with the RFID tag 12 is placed on the mount surface of the RFID-tag reader 13, with the surface having the RFID tag 12 in a downward direction. Instruction for reading is given to the RFID-tag reader 13 when a start button is pressed or is given with the function of sensing the weight of the article 11, if available.

When the RFID-tag reader 13 receives a read instruction, the article-range finder 31 first senses and recognizes the position and size of the article 11 using the optical sensor 14a and the photodetector 14b. The antenna-shift controller 32 then determines the moving range of the antenna 15 from the range information on the article 11 sensed and recognized by the article-range finder 31 and in consideration of the radio-wave arrival range.

The antenna-shift controller 32 of the carrier 16 instructs the antenna driving section 33 to move the antenna 15 along the rail 17 to the shift start position in the determined moving range using the drive motor.

After completion of the shift of the antenna 15 to the shift start position by the antenna-shift controller 32 of the carrier 16 has been confirmed, the antenna 15 tries to receive the signal of the RFID tag 12. When the reception from the RFID tag 12 has been made normally, the process of reading the RFID tag 12 is performed. On the other hand, the reception was not performed normally, the antenna-shift controller 32 moves the antenna 15 by a specified distance using the antenna driving section 33, and again tries reception of a signal from the RFID tag 12.

The trial of reception from the RFID tag 12 and the shift of the antenna 15 are repeated in the moving range of the antenna 15 until the reception from the RFID tag 12 is normally made under the control of the antenna-shift controller 32.

When the reception could not be executed normally in the moving range of the antenna 15, a notification that communication with the RFID tag 12 is unavailable is given and then the process is terminated.

In this way, the position and size of the article 11 can be recognized using the sensor 14 and the position of the RFID tag 12 can be limited within a specified range. The antenna 15 thus radiates radio waves while moving within the range. This configuration has the advantage of minimizing radio wave output and its emission range. This offers the effects of preventing a bad influence of radio wave interference to other electronic devices.

The foregoing embodiment uses an infrared optical sensor or the like as means for finding the position and size of articles. Optical sensing has the advantage of instantaneous sensing. However, in this invention, mechanical means may be used to determine the size etc.

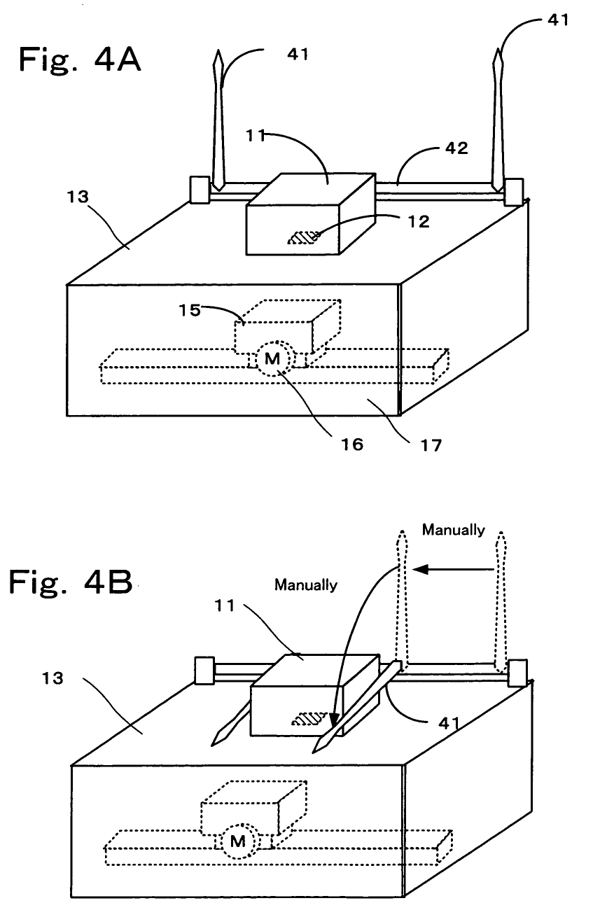

FIG. 4A shows a structural example of the embodiment. In place of the sensor 14 in the embodiment of FIG. 1, rod sensors 41 and a rod-sensor support member 42 that guides and supports the rod sensor 41 are disposed on the mount surface of the RFID-tag reader 13.

The two rod sensors 41 can be moved by hand on the rod-sensor support member 42 in the same direction as that of the antenna 15 and the carrier 16. Also, the rod sensors 41 can be turned around the rod-sensor support member 42 toward the mount surface.

The rod sensors 41 also have means for notifying the RFID-tag reader 13 of positional information in the state in which they tilt to the mount surface.

FIG. 4B shows the procedure of detecting and recognizing the position and size of the article 11, according to the embodiment. The rod sensor 41 in the initial position is moved along the arrow “manually” to the side of the article 11 placed on the RFID-tag reader 13. This operation is performed for the right and left rod sensors 41 to sandwich the article 11 with the two rod sensors 41. Upon receiving a read instruction, the RFID-tag reader 13 instructs the two right and left rod sensors 41 to issue positional information, and receives the positional information, and determines the moving range of the antenna 15. A procedure subsequent to the determination of the moving range of the antenna 15 is the same as that of the foregoing embodiment.

According to the embodiment, relatively low cost mechanical sensors can be used to determine the position and size of articles, thus offering the advantage of providing lower-cost RFID-tag readers.

When the position of the RFID tag on an article is unknown, it is also possible to find the range of the article not only in one direction but also in the direction perpendicular thereto, and to move the antennas in two dimensions within the range, thereby communicating with the RFID tag.

What is claimed is:

1. A desktop system for reading a radio-frequency-identification (RFID) tag, the system comprising:
an article-range finder for finding a range in which an article with an RFID tag is placed;
a reader having an antenna for communicating with the RFID tag; and
a carrier for carrying the antenna of the reader within the found range of the article.

2. The desktop system for reading an RFID tag, according to claim 1, wherein the article-range finder includes an optical sensor and a photodetector disposed so as to sandwich the article.

3. The desktop system for reading an RFID tag, according to claim 1, wherein the article-range finder is a mechanical sensor capable of moving so as to sandwich the article.

4. A desktop system for reading an RFID tag, comprising:
an article-range finder for measuring the length of an article with an RFID tag in one direction, the article being disposed on a casing;
an antenna disposed in the casing, for communicating with the RFID tag;
a carrier disposed in the casing, for carrying the antenna in one direction of the article; and
a communication section for allowing the antenna to communicate with the RFID tag when the antenna is moved by the carrier within the length of the article in one direction.

5. The desktop system for reading an RFID tag, according to claim 4, wherein the article-range finder includes an optical sensor and a photodetector disposed so as to sandwich the article.

6. The desktop system for reading an RFID tag, according to claim 4, wherein the article-range finder is a mechanical sensor capable of moving so as to sandwich the article.

7. A method for controlling the reading of an RFID tag, the method comprising:
an article-range finding step of finding a range in which an article with an RFID tag is placed;
a carrying step of carrying an antenna that communicates with the RFID tag within the range in which the article is placed; and
a communication step of communicating with the RFID tag while moving the antenna within the range in the carrying step.

8. The method for controlling the reading of an RFID tag according to claim 7, wherein, in the article-range finding step, the range in which the article is placed is found using an optical sensor and a photodetector disposed so as to sandwich the article.

9. The method for controlling the reading of an RFID tag according to claim 7, wherein, in the article-range finding step, the range in which the article is placed is found using a mechanical sensor capable of moving so as to sandwich the article.
